(19) United States
(12) Patent Application Publication
(10) Pub. No.: US 2014/0108129 A1
(43) Pub. Date: Apr. 17, 2014

(54) DETERMINING THE EFFECTIVENESS OF AN ADVERTISEMENT ON A WEBSITE OR MOBILE DEVICE

(71) Applicants: Daniel Victor Klein, Pittsburgh, PA (US); Dean Kenneth Jackson, Pittsburgh, PA (US)

(72) Inventors: Daniel Victor Klein, Pittsburgh, PA (US); Dean Kenneth Jackson, Pittsburgh, PA (US)

(73) Assignee: GOOGLE INC., Mountain view, CA (US)

(21) Appl. No.: 13/566,354

(22) Filed: Aug. 3, 2012

(51) Int. Cl. G06Q 30/02

(52) U.S. Cl. 705/14.45; 705/14.41

(57) ABSTRACT

A system and method for determining the effectiveness of an advertisement on a website or a mobile device is provided. The advertisement is provided for presentation on the website or the mobile device, and a presentation time is identified at which the advertisement was presented. The presentation of the advertisement is associated with a user profile. At least one of a location associated with the advertisement or a product associated with the advertisement is identified, and an acknowledgment of the advertisement associated with the user profile is identified based on the identified presentation time and the identified at least one of the location or the product, after the advertisement is first presented. An effectiveness of the advertisement based on the identified acknowledgment of the advertisement is determined.

### BACKGROUND

1. Field

The present disclosure generally relates to advertisements on a website or on mobile devices, and more particularly to determining the effectiveness of an advertisement on a website or a mobile device.

2. Description of the Related Art

Advertisements may be displayed on websites or through applications on mobile devices. The effectiveness of the advertisement is determined based on interactions of users with the advertisement such as clicking on the advertisement. The effectiveness of the advertisement may determine the cost, frequency of display, or placement of the advertisement within the website or within the application on the mobile device.

### SUMMARY

The disclosed subject matter relates to determining the effectiveness of an advertisement on a website or a mobile device. The method includes providing the advertisement for display on the website or the mobile device, wherein the display is associated with a user profile and identifying a presentation time at which the advertisement was presented. The method may also include identifying at least one of a location associated with the advertisement or a product associated with the advertisement and identifying an acknowledgment of the advertisement associated with the user profile based on the identified presentation time and the identified at least one of the location or the product, after the advertisement is first presented. The method additionally provides determining an effectiveness of the advertisement based on the identified acknowledgment of the advertisement.

The disclosed subject matter further relates to a system for determining the effectiveness of an advertisement on a website. The system includes one or more processor(s) and a memory containing processor-executable instructions. When executed by the processor(s), the system provides the advertisement for display on the website, wherein the display is associated with a user profile and identifies a display time at which the advertisement was displayed. The system also identifies a location associated with the advertisement, identifies a current location of a device associated with the user profile, and identifies a current time of the device. The system also determines whether the current location is the identified location associated with the advertisement and determines whether a span of time between the current time and the identified display time of the advertisement is less than or equal to a threshold duration. The system also identifies an acknowledgment of the advertisement associated with the user profile if the current location is the identified location associated with the advertisement and if the span of time is less than or equal to the threshold duration and determines an effectiveness of the advertisement based on the identified acknowledgment of the advertisement.

The disclosed subject matter also relates to a machine-executable storage medium comprising machine-readable instructions for causing a processor to perform a method for determining the effectiveness of an advertisement on a website. The method includes providing the advertisement for display on the website, wherein the display is associated with a user profile, identifying a display time at which the advertisement was displayed, identifying a product associated with the advertisement, and identifying a purchase of a product associated with the user profile. The method further includes identifying a purchase time of the purchase of the product associated with the user profile, determining whether the purchased product is the identified product associated with the advertisement, and determining whether a span of time between the purchase time and the identified display time of the advertisement is less than or equal to a threshold duration. The method also includes identifying the purchase as the acknowledgment of the advertisement if the purchased product is the identified product associated with the advertisement and the span of time is less than or equal to the threshold duration and determining an effectiveness of the advertisement based on the identified acknowledgment of the advertisement.

The disclosed subject matter relates to a computer-implemented method for determining the effectiveness of an advertisement on a website or a mobile device. The method includes providing the advertisement for presentation on the website or the mobile device, wherein the presentation is associated with a user profile and identifying a presentation time at which the advertisement was presented. The method also includes identifying a membership associated with the advertisement and identifying a membership check-in associated with the user profile. The method further includes identifying a check-in time of the membership check-in and determining whether the checked-in membership is the identified membership associated with the advertisement and the span of time is less than or equal to the threshold duration and determining the effectiveness of the advertisement based on the identified acknowledgment of the advertisement.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

Certain features of the subject technology are set forth in the appended claims. However, for the purpose of explanation, several aspects of the subject technology are set forth in the following figures.

FIG. 1 illustrates an example system for determining the effectiveness of an advertisement on a website.

FIG. 2 is a block diagram illustrating an example client and server from the system of FIG. 1.

FIG. 3 illustrates an example process for determining the effectiveness of an advertisement on a website.

FIG. 4 is an illustration of a flow for determining the effectiveness of an advertisement on a website.

FIG. 5 is a block diagram illustrating an electronic system with which some implementations of the subject technology are implemented.

### DETAILED DESCRIPTION

In the following detailed description, numerous specific details are set forth to provide a full understanding of the subject technology. It will be apparent, however, that different aspects of the subject technology may be practiced without some of these specific details. In other instances, well-known structures and techniques have not been shown in detail so as not to obscure the disclosure.

The disclosed subject matter describes systems and techniques for determining the effectiveness of an advertisement on a website. Online advertisements are shown to internet users through a web browser and may contain content that is directed to a store and/or a specific product. Use of the term “product” herein, including the claims, may refer to one or more physical products, one or more services, or any combination of one or more products and one or more services. An online advertisement may be associated with the user by virtue of a user's device (e.g., a mobile device that identifies the user) or associated with the user through the user's account associated with a web browser. The cost and effectiveness of an advertisement may be measured by the ad's clickthrough traffic, e.g., the number of times that users click on the ad. The frequency with which an advertisement appears and the placement of an advertisement may be weighted, where more heavily weighted advertisements may appear more frequently. However, the effectiveness of the advertisement measured in this manner is only based on the user's interaction with the advertisement and not by a more complete assessment of effectiveness-based actions of the user after the advertisement is no longer displayed. If a user merely views the advertisement but then visits a physical location of a store, uses a loyalty card associated with the advertisement, and/or purchases the advertised product or service, the advertisement should still be deemed successful. Accordingly, the effectiveness and cost of the advertisement may be more effectively determined if other actions of users are attributed as acknowledgements of the advertisement.

A visit to a physical location of a store and/or purchase of the advertised product or service are examples of events that can indicate that the advertisement has been effective to its audience. Such a visit or purchase may be identified through a mobile device of a user or through a transaction in which the user checks-in with a membership card associated with the user's profile. The location of the mobile device or communication services of the mobile device may determine the location of the user. Location of the mobile device may be determined based a navigation system, GPS, multilateration, or any other method of determining the location of an electronic device. That location may be compared to the location associated with the ad. The time of the user's visit to the physical location of the store may be determined and compared to the time at which the store's advertisement was displayed to the user. If the user visits the store associated with the advertisement within a predetermined span of time following the display of the ad, the user's visit to the store may be considered an acknowledgment of the advertisement. The predetermined span of time may be varied based on the type of product, the type of store, or can be determined based on agreement with the advertiser. Purchases may also be made with electronic applications installed on the user's mobile device. The product (or service) purchased may then be identified along with the location of the purchase and compared with the advertising content that has been displayed to the user. A purchase may be completed in any other manner and include a check-in of a loyalty or membership card that is associated with the user's profile. If the place of purchase, purchased product, or membership check-in matches the content of the advertisement, then the user's purchase may be an indication that the advertisement was effective. A predetermined span of time between the display of the advertisement to the user and time of the purchase may further be used to determine whether the advertisement was effective. The purchase of the product may then be considered an acknowledgment of the advertisement.

A purchase may be made with any other conventional form of payment including cash, credit card, check, coupon, or bartering and may still be associated with the user if a loyalty or membership card is used in conjunction with a purchase. The use of the membership card may still be associated with the user if a loyalty or membership card is used in conjunction with a purchase. The use of the membership card may then indicate the acknowledgment of the advertisement regardless of whether the membership card is used in conjunction with a purchase.

Other types of acknowledgement such as user actions in other applications, such as “checking in” on a social networking website or a user published comment on a micro blog indicating a purchase has been made, may be also considered as an acknowledgment of an advertisement. Different types of acknowledgements may be differently weighted when aggregating the total effectiveness of the advertisement. Different types of acknowledgements may include clickthrough on the advertisement itself, traffic though a physical store, purchase traffic, user actions in other online applications, and the like.

The weighted total of different types of acknowledgements may be used to determine the effectiveness and cost of the advertisement. Multiple acknowledgements from the same user for the same advertisement may be eliminated from the total to increase accuracy. Information associated with effectiveness of an advertisement based on different types of acknowledgments may additionally be used to determine the frequency and placement of the advertisement in the future display of the ad.

Examples provided herein describe a user's information (e.g., location and purchases) that may be associated with a user account. In example aspects, the user can, at any time, adjust appropriate privacy settings to selectively limit the types of user information that is accessed by the subject technology.

The user may adjust appropriate privacy settings to selectively limit the types of information that is shared with other users.

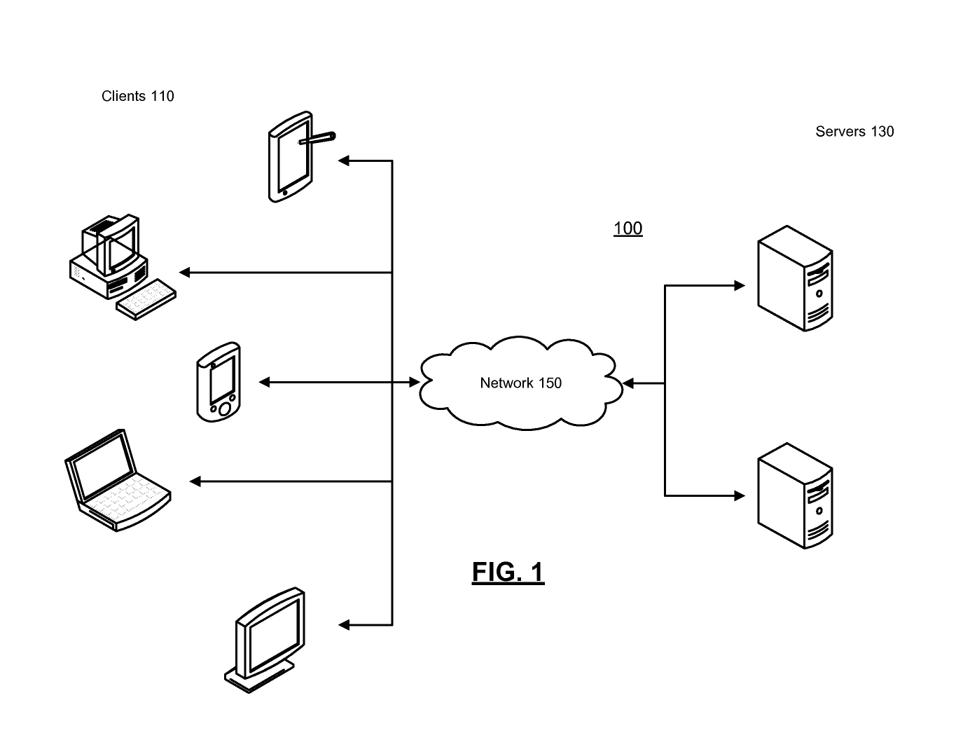

Turning to the drawings, FIG. 1 illustrates an example system 100 for determining the effectiveness of an advertisement on a website. The system 100 includes clients 110 and servers 130 connected over a network 150.

An advertisement may be sent from servers 130 over network 150 be displayed to a user on a client 110. Information regarding the purchases of a user, time and location information associated with the user may be sent from client 110 over network 150 to servers 130. The effectiveness of an advertisement may be determined by servers 130.

The system 100 is comprised of client(s) 110, server(s) 130 and the network 150 in any combination or configuration that allows for the determining of the effectiveness of an advertisement on a website, including implementations with multiple servers 130. Each of the clients 110 can be, for example, a desktop computer, a laptop computer, a mobile device (e.g., a smartphone, tablet computer, or PDA), a set top box (e.g., for a television), a television with one or more processors embedded therein or coupled thereto, a video game console, or any other device having an appropriate processor, memory, and communications capabilities. In certain instances, different versions and/or configurations of the system that include subject technology as disclosed herein are available for download from a server 130 and subsequent installation on client 110. The servers 130 can be any device having a processor, memory, and communications capability for hosting the data for installing and hosting the system. The network 150 can include, for example, any one or more of a personal area network (PAN), a local area network (LAN), a campus area network (CAN), a metropolitan area network (MAN), a wide area network (WAN), a broadband network (BBN), the Internet, and the like. Further, the network 150 can include, but is not limited to, any one or more of the following network topologies, including a bus network, a ring network, a mesh network, a star-bus network, tree or hierarchical network, and the like.

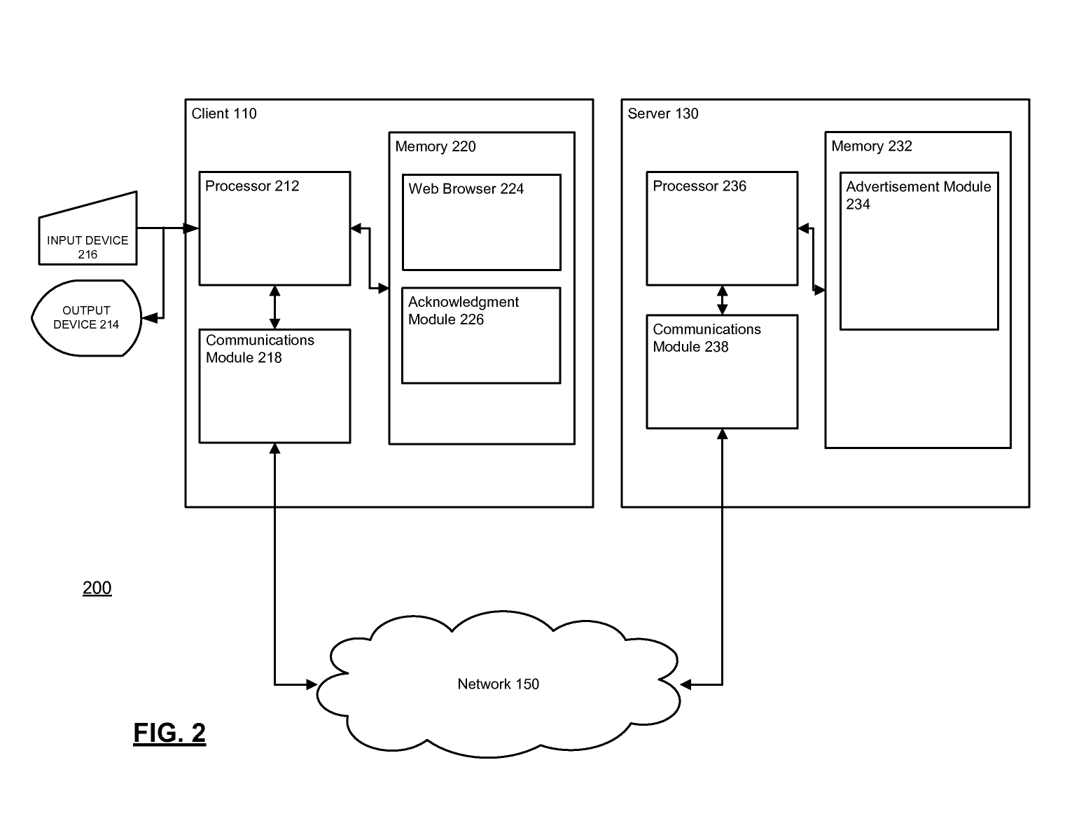

FIG. 2 is a block diagram illustrating an example client and server from the system 100 of FIG. 1 according to certain aspects of the subject technology. The client 110 and the server 130 are connected over the network 150 via respective communications modules 218 and 238 and are configured to interface with the network 150 to send and receive information, such as data, requests, responses, and commands to other devices on the network. The communications modules 218 and 238 can be, for example, modems or Ethernet cards.

The client 110 includes a processor 212, a communications module 218, and a memory 220 that may include a web browser 224 and an acknowledgment module 226. Memory 220 may additionally include a database for storing user purchase information, user location information, and the like. The processor 212 of the client 110 is configured to execute instructions, such as instructions physically coded into the processor 212, instructions stored in memory 220, or a combination of both. For example, the input device 216 may provide input to processor 212 which is processed by a web browser 224 stored in memory 220. Acknowledgment module 226 may process input related to current GPS location information in addition to purchase information. The input may then be sent through network 150 via communications module 218 to server 130, which receives the input through communications module 238.

Server 130 includes a processor 236, a communications module 238, and a memory 232 that may include an advertisement module 234. Memory 232 may additionally include a database that stores information related to advertisements and information related to the effectiveness of those advertisements. Processor 236 is configured to execute instructions, such as instructions physically coded into the processor 236, instructions stored in memory 232, or a combination of both.

Processor 236 processes information from advertisement module 234 and sends information through communications module 238, through network 150, to client 110 to be displayed on output device 214.

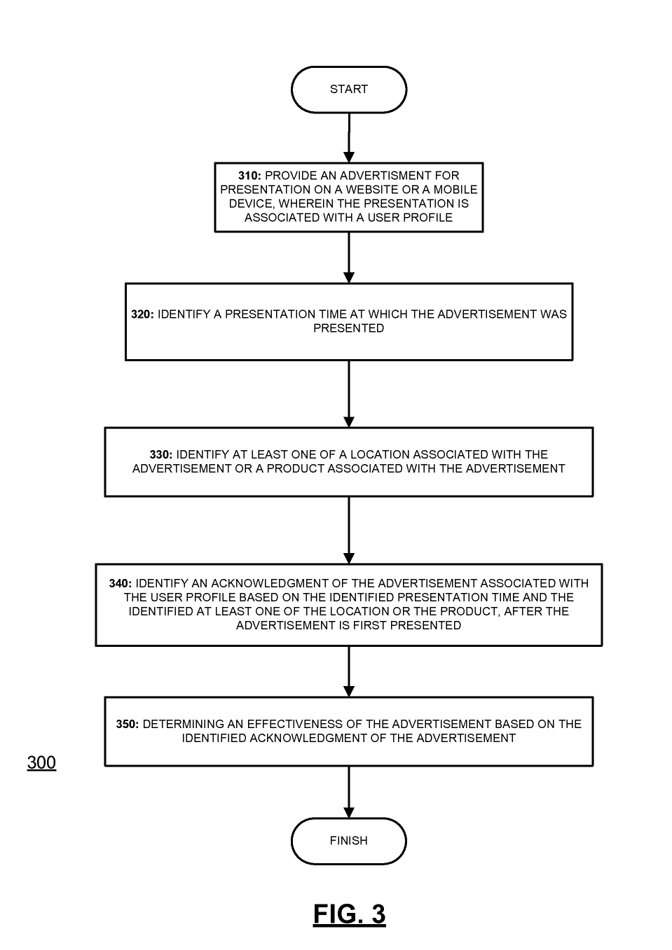

FIG. 3 illustrates an example process 300 for determining the effectiveness of an advertisement on a website as shown by the example client 110 and server 130 of FIG. 2. Although process 300 of FIG. 3 is described with reference to FIG. 2, the process 300 is not limited to such a configuration and can be applied to other systems and configurations.

The process begins with step 310, in which an advertisement is provided for presentation on a website or a mobile device, wherein the presentation is associated with a user profile. The user profile may be stored on in memory 232 of servers 130 and may also be associated with one or more clients 110. The term “advertisement” as used herein encompasses its plain and ordinary meaning, including, but not limited to any electronic advertisement shown to a user through a device associated with the user. The advertisement may be shown on a website through a web browser, through a user interface of an installed application, and the like. The advertisement may be composed of text, an image, a video, audio, or a combination. The advertisement may allow user interaction that may cause an advertisement to be presented. The user may be able to purchase goods or service by interacting with the advertisement. The advertisement may be associated with a product or a service, may be associated with a location (e.g., a retail store), may be associated with a brand name, store name, organization, or may be associated with a product or a service at a specific location. In one of many possible examples, the advertisement may be presented on a website through web browser 224 and displayed to a user on output device 214 of client 110.

In step 320, a presentation time at which the advertisement was presented is identified. The presentation time may indicate the time at which the advertisement appears on the website or on the application of the mobile device. A presentation time may be recorded for each instance that the advertisement is presented and is specific to the user to which it was presented. The presentation time may be identified by advertisement module 234 and stored in associated with the advertisement in memory 232. The presentation time may refer to the beginning time of the duration for a single instance in which the advertisement is presented. The presentation time may also refer to the ending time of the duration of an audio, and/or video advertisement, or the ending time of the display of an image.

In step 330, at least one of a location associated with the advertisement or a product associated with the advertisement is identified. The location associated with the advertisement may be a single location of a physical location of a store, multiple locations, or the locations of “authorized sellers.” The location associated with the advertisement may be specific to the user profile, (e.g., a user whose device is physically located in Chicago, Ill., may be shown an advertisement for a national retail store with only Illinois locations listed for the user).

A membership may be associated with the advertisement. A membership associated with the advertisement may be the name of a business, an advertisement for a discount associated with use of the membership card, an advertisement for a business that is has a membership or loyalty program, or the like. The membership or loyalty card need not be mentioned or displayed on the face of the advertisement or in the advertisement's content to be associated with the advertisement.

In step 340, an acknowledgment of the advertisement associated with the user profile is identified based on the identified presentation time and the identified at least one of the location or the product, after the advertisement is first presented. An acknowledgment of the advertisement may also be identified based on a membership check-in indicating that the user has entered a physical store or made a purchase. The term “acknowledgement of the advertisement” as used herein encompasses its plain and ordinary meaning, including, but not limited to actions of the user that does not include interacting with the advertisement itself (e.g., clicking on or passing a cursor over the advertisement in the website) that indicate that the user associated with the user profile has seen the advertisement. Examples of acknowledgments that are non-interactive with the advertisement itself include, but are not limited to, a user's physical presence in the location associated with the advertisement (e.g., a mobile device associated with the user's profile is identified as being in the same location that is associated with the advertisement), purchase of the advertised product or service, purchase of the advertised product or service at the location associated with the advertisement, purchase of the advertised product or service via telephone, check-in using a membership card, a purchase using a membership card, and the like.

An acknowledgment of the advertisement based on the user's physical presence in the location associated with the advertisement may include identifying a current location and a current time of the user. Current location and current time may be determined by the client 110 associated with the user and identified by advertisement module 234. A check in-time associated with a membership check-in may not be associated with a client 110 that is directly associated with the user. For example, a client 110 belonging to the advertised business may determine a membership check-in time associated with the user profile.

Advertisement module 234 may then determine whether the current location of the user is the identified location associated with the advertisement. The current location may be determined to be the identified location if the current location is within a predetermined proximity of any location associated with the advertisement. The predetermined proximity may be any distance from a location associated with the advertisement that indicates the user is in the vicinity of the location associated with the advertisement.

Advertisement module 234 may determine whether a span of time between the current time (or membership check-in time) and the presentation time of the advertisement is less than or equal to a threshold duration. The threshold duration may vary based on the product type including, but not limited to, the type of good or service being sold, the model of the product, color, an incentive, size, expiration date, a combination of different product types (such as both brand and model), and multiple varieties of the same product type (such as red, white, and blue). The threshold duration may also vary based on the location that is associated with it. The threshold duration may also vary based on a product type incentive offered specifically to users with memberships.

In one example related to location, the threshold duration for a car dealership advertisement in Pittsburgh may differ from a car dealership advertisement in Chicago. The threshold duration for a car dealership may be a span of time that is longer than the threshold duration for a grocery store advertisement. Threshold duration may vary based on both product type and location. The threshold duration may be associated with an offer that is advertised in the advertisement. For instance, the threshold duration may be set to correspond to a special deal in the advertisement that expires within a set time frame (e.g., 15% off the user's entire purchase before April 1).

The user's current time, the presentation time of the advertisement and the threshold duration may have additional limitations to prevent incidental purchases and incidental visits to locations from being considered as acknowledgements of advertisements. For example, if a user arrives at a shoe store before the user actually receives an advertisement for that particular shoe store, the user's arrival should not be considered an acknowledgment of the advertisement. Accordingly, the presentation time of the advertisement may be required to precede the user's arrival time at the store (i.e., the current time of the user) for the user's arrival to be considered an acknowledgement of the advertisement.

One exception to the above example may occur if the user subsequently purchases a pair of shoes because that particular brand of shoe was presented to him in the advertisement on the user's mobile device while he was in the store. If the above time requirements are observed, and the current time of the user is the arrival time at the store, the user's purchase will not be considered an acknowledgment of the advertisement.

To ensure the user's shoe purchase is considered to be an acknowledgment of the advertisement, a second threshold duration may be used if the current time precedes or is the same as the presentation time of the advertisement. The second threshold duration used for an exception may be much shorter than the threshold duration used for the general case.

The current location of the user (e.g., the user's location as provided by the user's mobile device) may be identified as the acknowledgment of the advertisement if the user's location is the location associated with the advertisement and if the span of time between the current time and the presentation time is less than or equal to the threshold duration.

An acknowledgment of the advertisement based on a purchase of the product that is associated with the advertisement may include identifying a purchase of a product associated with the user and a purchase time of the purchase of the product associated with the user profile. The purchase of the product may be conducted through the client 110 or otherwise associated with the user profile and identified by advertisement module 234. Advertisement module 234 may then determine whether the purchased product is the identified product associated with the advertisement. The purchased product may be identified as a product associated with the advertisement if it is the same as the advertised product, a brand of product that is the same as the brand of product advertised, or any product sold at a location for an advertisement directed to a specific location (e.g., any item purchased at the advertised grocery store).

Advertisement module 234 may determine whether a span of time between the purchase time of the user and the presentation time of the advertisement is less than or equal to a threshold duration in a similar manner as outlined above.

The advertisement module 234 may identify the purchase associated with the user profile as the acknowledgment of the advertisement if the purchased product is the identified product associated with the advertisement and the span of time is less than or equal to the threshold duration. An acknowledgement of the advertisement may be further identified if the user's purchase of the product occurs at a location associated with the advertisement.

The advertisement module 234 may identify the membership check-in associated with the user profile as the acknowledgment of the advertisement if the membership check-in is the membership that is associated with the advertisement that was presented to the user and within the span of time that is less than or equal to the threshold duration. An acknowledgment of the advertisement may be further identified if the user's membership check-in occurs at a location associated with the advertisement and/or a purchase of an advertised product is made.

In other aspects of the subject technology, the acknowledgment of the advertisement may occur after the advertisement is no longer displayed or after a video or audio portion of the advertisement has ended. The advertisement or a portion of the advertisement may be maintained for display by the user on the user's device after it is first displayed or played, and the acknowledgment of the advertisement by the user still occurs without the direct interaction of the user with the advertisement as it is presented.

The process ends in step 350, an effectiveness of the advertisement is determined based on the identified acknowledgment of the advertisement. The effectiveness of the advertisement may be determined based on some or all identified acknowledgments of the advertisement of users that have been presented with the advertisement. Acknowledgments of the same advertisement shown to different users may be stored in a database of memory 232 of servers 130. A type of acknowledgment of the advertisement may be determined (e.g., an acknowledgment based on location, an acknowledgment based on product purchase, an acknowledgment based on the product purchase and location, an acknowledgment of the advertisement based on user interaction with the advertisement, or the like). Acknowledgment of the advertisement may be weighted based on the type of the acknowledgment based on a predetermined weight. Acknowledgments that are associated with a purchase may be more heavily weighted than acknowledgments that are not associated with a purchase.

Multiple acknowledgments of a single presentation of the advertisement to a user may be made by that user. For instance, the user may interact with the advertisement itself, may physically go to the location associated with the advertisement, and may purchase the advertised product. Each of these types of acknowledgments may be differently weighted. The total effectiveness of the advertisement as determined from the presentation of the advertisement to many users at different times (and including multiple presentations of the advertisement to the same user) may be determined by considering only the most heavily weighted acknowledgment for each user for each presentation of the advertisement of the user. In the above example, the purchase of the advertised product may be the most heavily weighted acknowledgment, and thus the other two acknowledgments of the advertisement by the user may not be considered in determining the total effectiveness of the advertisement.

Other measurements of the effectiveness may contribute to the determination of the total effectiveness of the advertisement. The total user traffic for a particular advertisement space may be compared to the number of times the advertisement is actually shown in that space (e.g., The total visitor traffic on a website may be compared with the number of users that were shown the advertisement, or the number of times an application has been opened may be compared with the number of times a specific advertisement has been presented in that application). The number of presentations of the advertisement may be compared to the number of users whose location can be identified to a specific degree of certainly, such as a geographic radius.

Future presentation of the advertisement may be based on the total effectiveness of the advertisement. One or more of the placement of the advertisement on the web site or display of an application, the size, the frequency, order of audio play, or the like may be dictated by the effectiveness of the advertisement.

Some or all information associated with the effectiveness of the advertisement may be used as a sales tool. An advertiser may be provided with information associated with the effectiveness of the advertisement to indicate the success of the advertisement and to promote retention of advertisers. Access to specific information associated with the effectiveness of the advertisement may be provided to the advertiser as a separate service, included in the cost of the advertisement, a complimentary service, or as an incentive. The cost of the advertisement may also be determined based on the effectiveness of the advertisement.

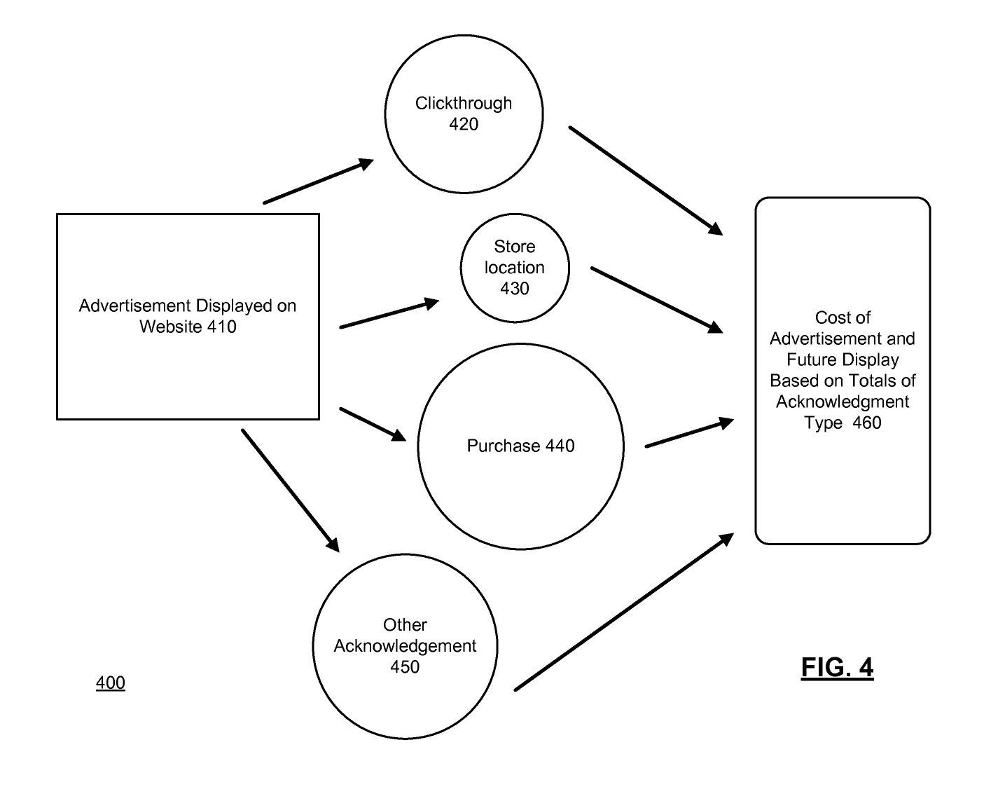

FIG. 4 is an illustration of a flow for determining the effectiveness of an advertisement in a use case including a website. The advertisement is displayed to users through websites 410. Following the display of the advertisement, different types of acknowledgments of the advertisement occur such as clickthrough acknowledgments 420, visits to a physical location of a business associated with the acknowledgment 430, purchase of the advertised product 440, or other types of advertisements 450. The acknowledgments from different users are totaled and weighted based on the type of acknowledgment (e.g., the total effectiveness of the advertisement), and then used to determine the cost of the advertisement and future display of that advertisement 460.

Many of the above-described features and applications are implemented as software processes that are specified as a set of instructions recorded on a computer-readable storage medium (also referred to as computer-readable medium). When these instructions are executed by one or more processing unit(s) (e.g., one or more processors, cores of processors, or other processing units), they cause the processing unit(s) to perform the actions indicated in the instructions. Examples of computer-readable media include, but are not limited to, CD-ROMs, flash drives, RAM chips, hard drives, EPROMs, etc. The computer-readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some implementations, multiple software aspects of the subject technology can be implemented as sub-parts of a larger program while remaining distinct software aspects of the subject technology. In some implementations, multiple software aspects can also be implemented as separate programs. Finally, any combination of separate programs that together implement a software aspect described here is within the scope of the subject technology. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

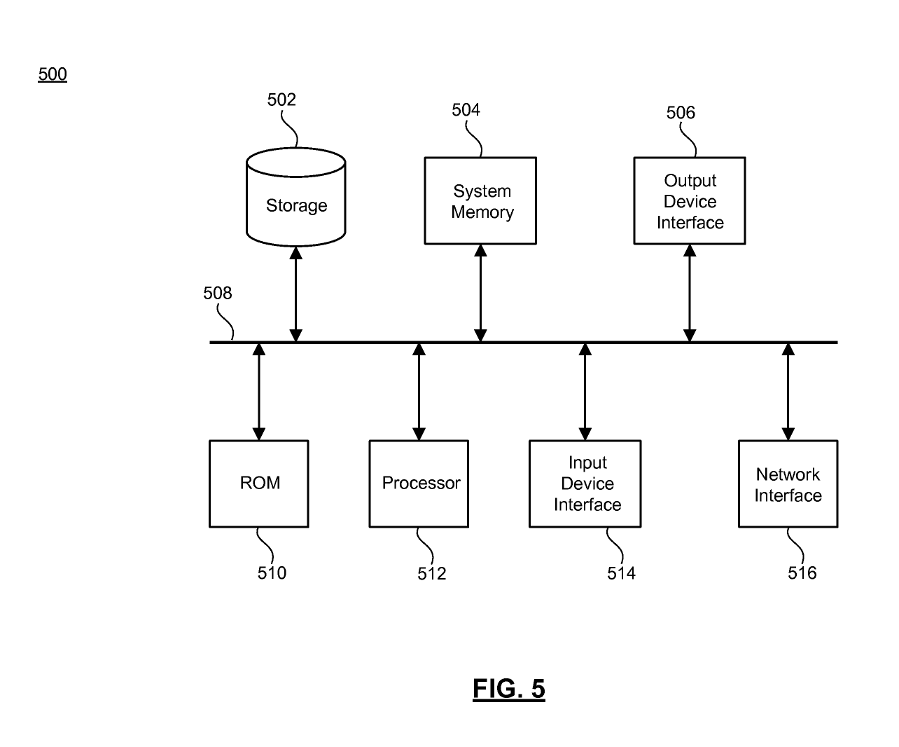

FIG. 5 conceptually illustrates an electronic system with which some implementations of the subject technology are implemented. Electronic system 500 can be a computer, phone, PDA, or any other sort of electronic device. Such an electronic system includes various types of computer-readable media and interfaces for various other types of computer-readable media. Electronic system 500 includes a bus 508, processing unit(s) 512, a system memory 504, a read-only memory (ROM) 510, a permanent storage device 502, an input device interface 514, an output device interface 506, and a network interface 516.

Bus 508 collectively represents all system, peripheral, and chipset buses that communicatively connect the numerous internal devices of electronic system 500. For instance, bus 508 communicatively connects processing unit(s) 512 with ROM 510, system memory 504, and permanent storage device 502.

From these various memory units, processing unit(s) 512 retrieves instructions to execute and data to process in order to execute the processes of the subject technology. The processing unit(s) can be a single processor or a multi-core processor in different implementations.

ROM 510 stores static data and instructions that are needed by processing unit(s) 512 and other modules of the electronic system. Permanent storage device 502, on the other hand, is a read-and-write memory device. This device is a non-volatile memory unit that stores instructions and data even when electronic system 500 is off. Some implementations of the subject technology use a mass-storage device (such as a magnetic or optical disk and its corresponding disk drive) as permanent storage device 502.

Other implementations use a removable storage device (such as a floppy disk and its corresponding disk drive or a flash drive) as permanent storage device 502. Like permanent storage device 502, system memory 504 is a read-and-write memory device. However, unlike storage device 502, system memory 504 is a volatile read-and-write memory, such as random access memory. System memory 504 stores some of the instructions and data that the processor needs at runtime. In some implementations, the processes of the subject technology are stored in system memory 504, permanent storage device 502, and/or ROM 510. For example, the various memory units include instructions for determining the effectiveness of an advertisement on a website in accordance with some implementations. From these various memory units, processing unit(s) 512 retrieves instructions to execute and data to process in order to execute the processes of some implementations.

Bus 508 also connects to input and output device interfaces 514 and 506. Input device interface 514 enables the user to communicate information and select commands to the electronic system. Input devices used with input device interface 514 include, for example, alphanumeric keyboards and pointing devices (also called “cursor control devices”). Output device interface 506 enables, for example, the display of images generated by the electronic system 500. Output devices used with output device interface 506 include, for example, printers and display devices, such as cathode ray tubes (CRT), liquid crystal displays (LCD), or light emitting diode (LED) displays. Some implementations include devices such as a touchscreen that functions as both input and output devices.

Finally, as shown in FIG. 5, bus 508 also couples electronic system 500 to a network (not shown) through a network interface 516. In this manner, the computer can be a part of a network of computers such as a local area network (“LAN”), a wide area network (“WAN”), or an Intranet, or a network of networks, such as the Internet. Any or all components of electronic system 500 can be used in conjunction with the subject technology.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessors or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer-readable medium” and “computer-readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT, LCD monitor, or LED monitor for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Aspects of the subject matter described in this specification can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., advertisement hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some aspects, a server transmits data (e.g., an HTML page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of example approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject technology. Features described under one heading or one subheading of the subject disclosure may be combined, in various embodiments, with features described under other headings or subheadings. Further it is not necessarily the case that all features under a single heading or a single subheading are used together in embodiments.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

The word “exemplary” is used herein to mean “serving as an example or illustration.” Any aspect or design described herein as “exemplary” is not necessarily to be construed as preferred or advantageous over other aspects or designs.

All structural and functional equivalents to the elements of the various aspects described throughout this disclosure that are known or later come to be known to those of ordinary skill in the art are expressly incorporated herein by reference and are intended to be encompassed by the claims.

1. A computer-implemented method for determining an effectiveness of an advertisement on a mobile device, the method comprising:
providing, using one or more computing devices, the advertisement for presentation on the mobile device, wherein the presentation is associated with a user profile;
identifying, using one or more computing devices, a presentation time at which the advertisement was presented;
identifying, using one or more computing devices, at least one of a location associated with the advertisement or a product associated with the advertisement, wherein identifying the location comprises identifying a current time of the mobile device and determining whether a span of time between the current time of the mobile device and the identified presentation time of the advertisement is less than or equal to a threshold duration, wherein identifying the product comprises identifying a purchase time of the purchase of the product associated with the user profile and determining whether a span of time between the purchase time and the identified presentation time of the advertisement is less than or equal to the threshold duration;
identifying, using one or more computing devices, an acknowledgment of the advertisement associated with the user profile based on the identified presentation time and the identified at least one of the location or the product, after the advertisement is first presented;
determining, using one or more computing devices, the effectiveness of the advertisement based on the identified acknowledgment of the advertisement and a plurality of acknowledgements resulting from other presentations of the advertisement.

2. The method of claim 1, wherein the presentation time is an ending time of a duration of presentation of the advertisement.

3. The method of claim 1, wherein the acknowledgment of the advertisement occurs after the presentation of the advertisement has ended.

4. The method of claim 1, wherein identifying the location further comprises:
identifying a current location of the mobile device associated with the user profile;
determining whether the current location is the identified location associated with the advertisement; and
identifying the current location as the acknowledgment of the advertisement if the current location is the identified location associated with the advertisement and the span of time is less than or equal to the threshold duration.

5. The method of claim 1, wherein identifying the product further comprises:
identifying a purchase of a product associated with the user profile;
determining whether the purchased product is the identified product associated with the advertisement; and
identifying the purchase as the acknowledgment of the advertisement if the purchased product is the identified product associated with the advertisement and the span of time is less than or equal to the threshold duration.

6. The method of claim 1, further comprising:
identifying a type of the acknowledgment of the advertisement;
weighting, using a predetermined weight, the acknowledgment based on the identified type of the acknowledgement of the advertisement; and
determining the effectiveness of the advertisement based on a total of weighted acknowledgments of the advertisement from a plurality of users.

7. The method of claim 6, further comprising:
determining the effectiveness of the advertisement based on a most heavily weighted acknowledgment of the advertisement received from each of a plurality of user profiles.

8. The method of claim 1, further comprising:
identifying a purchase of a product associated with the user profile at a current location of the mobile device associated with the user profile, wherein the acknowledgment of the advertisement is identified if the current location corresponds to the identified location associated with the advertisement.

9. The method of claim 1, wherein a second threshold duration is associated with a product type associated with the advertisement.

10. The method of claim 7, wherein future frequency and presentation of the advertisement is based on the effectiveness of the advertisement.

11. A system for determining an effectiveness of an advertisement on a website, the system comprising:
one or more processors; and
a memory containing processor-executable instructions that, when executed by the one or more processors, cause the system to:
provide the advertisement for display on the website, wherein the display is associated with a user profile;
identify a display time at which the advertisement was displayed;
identify a location associated with the advertisement;
identify a current location of a device associated with the user profile;
identify a current time of the device;
determine whether the current location is the identified location associated with the advertisement;
determine whether a span of time between the current time and the identified display time of the advertisement is less than or equal to a threshold duration;
identify an acknowledgment of the advertisement associated with the user profile if the current location is the identified location associated with the advertisement and if the span of time is less than or equal to the threshold duration; and
determine the effectiveness of the advertisement based on the identified acknowledgment of the advertisement and a plurality of acknowledgements resulting from other presentations of the advertisement.

12. The system of claim 11, wherein the display time is a beginning time of a duration of display of the advertisement.

13. The system of claim 11, wherein the system is further caused to:
identify a type of the acknowledgment of the advertisement;
weight, using a predetermined weight, the acknowledgment based on the identified type of the acknowledgement of the advertisement; and
determine the effectiveness of the advertisement based on a total of weighted acknowledgments of the advertisement from a plurality of users.

14. The system of claim 13, wherein the system is further caused to:
determine the effectiveness of the advertisement based on a most heavily weighted acknowledgment of the advertisement received from each of a plurality of user profiles.

15. The system of claim 11, wherein the system is further caused to:
identify whether a purchase of a product associated with the user profile corresponds to the current location, and wherein the acknowledgment of the advertisement is identified if the purchase of the product is identified.

16. The system of claim 11, wherein the threshold duration is associated with the location associated with the advertisement.

17. The system of claim 11, wherein future frequency and display of the advertisement is based on the effectiveness of the advertisement.

18. A non-transitory machine-readable storage medium storing machine-executable instructions for causing a processor to perform a method for determining an effectiveness of an advertisement on a website, the method comprising:
providing the advertisement for display on the website, wherein the display is associated with a user profile;
identifying a display time at which the advertisement was displayed;
identifying a product associated with the advertisement;
identifying a purchase of a product associated with the user profile;
identifying a purchase time of the purchase of the product associated with the user profile;
determining whether the purchased product is the identified product associated with the advertisement;
determining whether a span of time between the purchase time and the identified display time of the advertisement is less than or equal to a threshold duration;
identifying the purchase as the acknowledgment of the advertisement if the purchased product is the identified product associated with the advertisement and the span of time is less than or equal to the threshold duration; and
determining the effectiveness of the advertisement based on the identified acknowledgment of the advertisement and a plurality of acknowledgements resulting from other presentations of the advertisement.

19. The non-transitory machine-readable storage medium of claim 18, wherein the display time is a beginning time of a duration of display of the advertisement.

20. The non-transitory machine-readable storage medium of claim 18, further comprising:
identifying a type of the acknowledgment of the advertisement;
weighting, using a predetermined weight, the acknowledgment based on the identified type of the acknowledgement of the advertisement; and
determining the effectiveness of the advertisement based on a total of weighted acknowledgments of the advertisement from a plurality of users.

21. The non-transitory machine-readable storage medium of claim 20, further comprising:
determining the effectiveness of the advertisement based on a most heavily weighted acknowledgment of the advertisement received from each of a plurality of user profiles.

22. The non-transitory machine-readable storage medium of claim 18, further comprising:
identifying whether the purchase of the product associated with the user profile is at a location associated with the advertisement, and wherein the acknowledgment of the advertisement is identified if the purchase of the product is at the identified location associated with the advertisement.

23. The non-transitory machine-readable storage medium of claim 18, wherein the threshold duration is associated with a product type associated with the advertisement.

24. The non-transitory machine-readable storage medium of claim 18, wherein future frequency and display of the advertisement is based on the effectiveness of the advertisement.

25. A computer-implemented method for determining an effectiveness of an advertisement on a website or a mobile device, the method comprising:
providing, using one or more computing devices, the advertisement for presentation on the website or the mobile device, wherein the presentation is associated with a user profile;
identifying, using one or more computing devices, a presentation time at which the advertisement was presented;
identifying, using one or more computing devices, a membership associated with the advertisement;
identifying, using one or more computing devices, a membership check-in associated with the user profile;
identifying, using one or more computing devices, a check-in time of the membership check-in;
determining, using one or more computing devices, whether the checked-in membership is the identified membership associated with the advertisement;
determining, using one or more computing devices, whether a span of time between the check-in time and the identified presentation time of the advertisement is less than or equal to a threshold duration;
identifying, using one or more computing devices, the membership check-in as an acknowledgment of the advertisement if the checked-in membership is the identified membership associated with the advertisement and the span of time is less than or equal to the threshold duration; and
determining, using one or more computing devices, the effectiveness of the advertisement based on the identified acknowledgment of the advertisement and a plurality of acknowledgements resulting from other presentations of the advertisement.

26. The method of claim 1, wherein the threshold duration varies based on a product type.

27. The method of claim 1, wherein the threshold duration varies based on the location associated with the threshold duration.
